(19) United States
(12) Patent Application Publication
(10) Pub. No.: US 2026/0194174 A1
(43) Pub. Date: Jul. 9, 2026

(54) CAMLOCK CAP

(71) Applicant: Little Stinker Septic Services, Bozeman, MT (US)

(72) Inventor: Wade A. Dooley, Bozeman, MT (US)

(73) Assignee: Little Stinker Septic Services, Bozeman, MT (US)

(21) Appl. No.: 19/012,642

(22) Filed: Jan. 7, 2025

(51) Int. Cl. F16L 55/115

(52) U.S. Cl. CPC F16L 55/1157

(57) ABSTRACT

Disclosed embodiments include a camlock cover for covering a hose end. Embodiments include an endcap, a sidewall, at least one camlock, and a handle connected to the endcap.

### FIELD OF THE DISCLOSURE

This disclosure relates generally to camlock covers or caps for hoses and the like. More particularly, this disclosure relates to improvements to camlock covers to, among other things, facilitate easier transport and handling of camlock equipped hoses and the like.

### BACKGROUND

Conduits, flexible pipes, hoses (herein, collectively, “hoses”) and the like are used in many applications. For example, delivery of petroleum products from tanker trucks to holding tanks, emptying septic tanks, filling swimming pools, filling irrigation systems, fire fighting, and the like. These types, and other, hoses can often be anywhere from about 3 inches to 8 inches in diameter and, in some applications, need to extend for hundreds of feet. Also, in some applications, the hoses may be reinforced or otherwise structurally configured to handle high pressures. These types of hoses can typically weigh from 1 lb/ft to 10 lb/ft or more.

These hoses also require camlock covers and/or other fittings to seal the ends during transport and connect segments of hose together. Such fittings add to the overall weight of the hose.

Furthermore, the operator often needs to transport at least one end of the hose to the filling or emptying location and connect it to the operative port. That transportation often needs to be done by hand (i.e., carrying and/or dragging the hose). Thus, under the best of conditions, hoses can be difficult to transport and connect.

Additionally, environmental conditions are often not ideal. For example, delivery to or emptying from tanks often is performed year-round in extremely hot, cold, wet, slippery, or other challenging environments. Likewise, the substances being delivered or emptied (e.g., petroleum fuels, etc.) require the operator to wear gloves and other protective gear, making transport of the hose additionally difficult. Other difficulties, drawbacks, inconveniences, and inefficiencies of current systems also exist.

### SUMMARY

Accordingly, disclosed embodiments address the above, and other, difficulties, drawbacks, inconveniences, and inefficiencies of current systems.

Disclosed embodiments include a camlock cover including an endcap, a sidewall, at least one camlock, and a handle connected to the endcap.

In some embodiments the handle is integrally formed on the camlock cover. In some embodiments the handle is welded to the camlock cover.

In some embodiments the camlock cover includes a grip aid on the handle. In some embodiments the the grip aid is a thermally insulating material. In some embodiments the grip aid is an electrically insulating material.

Disclosed embodiments also include a hose fitting having an endcap, a sidewall, and a handle connected to the endcap. In some embodiments the hose fitting includes at least one camlock that secures the hose fitting to a hose end.

In some embodiments the handle is integrally formed on the hose fitting. In some embodiments the handle is welded to the hose fitting.

In some embodiments the hose fitting includes a grip aid on the handle. In some embodiments the grip aid comprises a thermally insulating material. In some embodiments the grip aid comprises an electrically insulating material. Other embodiments also exist.

### BRIEF DESCRIPTION OF THE DRAWINGS

FIG. 1 is an isometric, top view of a camlock cover in accordance with disclosed embodiments.

FIG. 2 is an isometric, bottom, inside view of a camlock cover in accordance with disclosed embodiments.

FIG. 3 is another isometric, bottom, inside view of a camlock cover in accordance with disclosed embodiments.

FIG. 4 is an isometric, top, outside view of a camlock cover in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

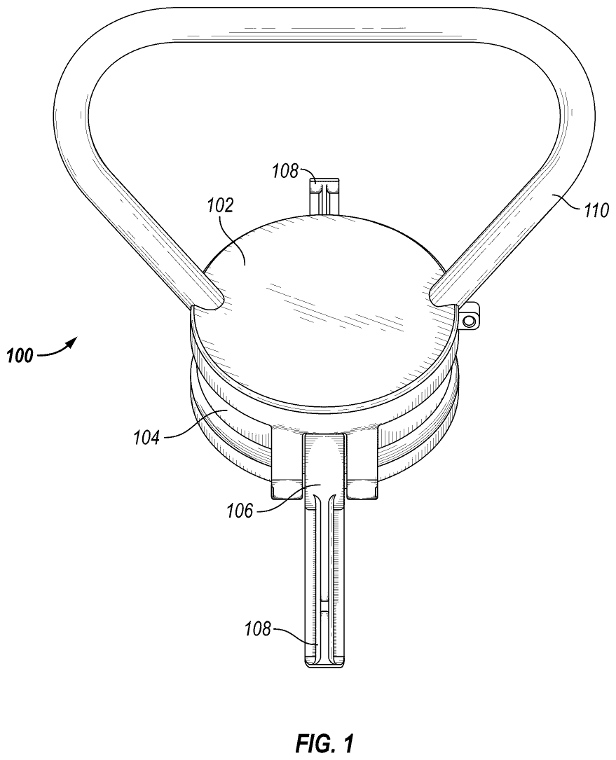

FIG. 1 is an isometric, top view of a camlock cover 100 in accordance with disclosed embodiments. As shown, camlock cover 100 includes an end cap 102 and a sidewall 104. In the embodiment shown, camlock cover 100 is an end cap 102 configured to seal and cover the end of a hose (not shown). As also shown embodiments of camlock cover 100 also include one or more cams 106 configured to engage mating portions on a hose end and lock the cover 100 (or other fitting) onto the hose end when lever 108 is pivoted. As used herein “camlock” refers to the locking interface for two or more pieces of hose, hose fittings, or combinations thereof, and means any of the male end, the female end, or both.

Embodiments of camlock cover 100 also include handle 110. As those of ordinary skill in the art having the benefit of this disclosure will understand, handle 110 facilitates the transportation and handling of any hose attached to camlock cover 110. Embodiments of handle 110 are configured as shown to be easily graspable by an operator and large enough to accommodate gloves or other safety gear that may be worn by the operator. Embodiments of handle 110 may be integrally formed onto end cap 102 (e.g., by casting), may be welded, or otherwise adhered to end cap 102 or sidewall 104, may be secured with fasteners (e.g., bolts), or the like. As those of ordinary skill in the art having the benefit of this disclosure will understand, handle 110 may be formed in a variety of shapes, sizes, and materials as desired. Additionally, embodiments of camlock cover 100 may be formed of metals, plastics, composites, or combinations of the same.

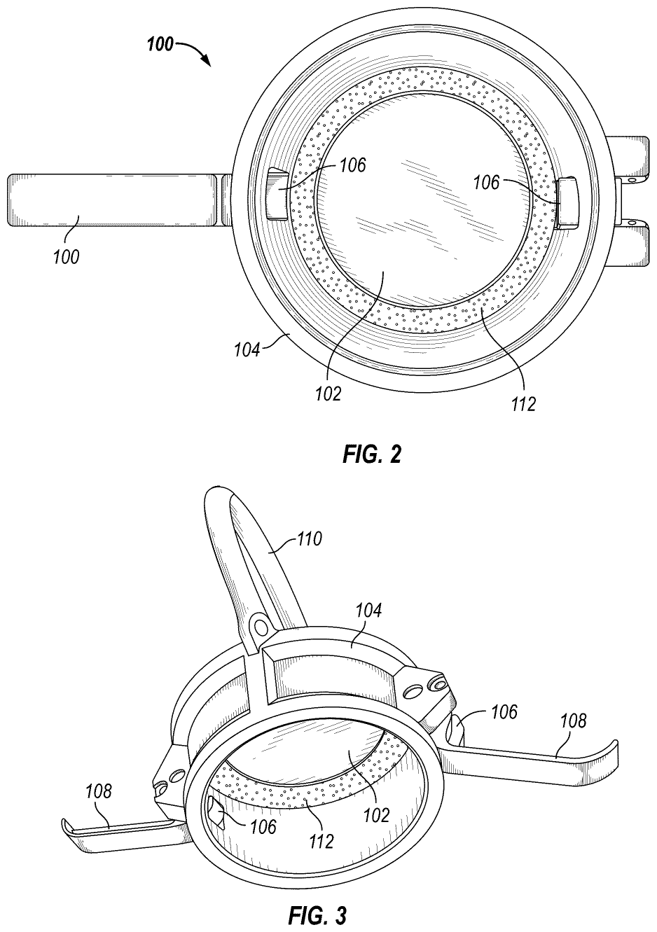

FIG. 2 is an isometric, bottom, inside view of a camlock cover 100 in accordance with disclosed embodiments. As shown cams 106 selectively protrude through sidewall 104 when lever 108 is pivoted to engage mating portions on a hose end and lock the cover 100 (or other fitting) onto the hose end. As also shown embodiments of camlock cover 100 may include gasket 112 or other seals to assist in sealing the camlock cover 100 to the hose end. FIG. 3 is another isometric, bottom, inside view of a camlock cover 100 in accordance with disclosed embodiments.

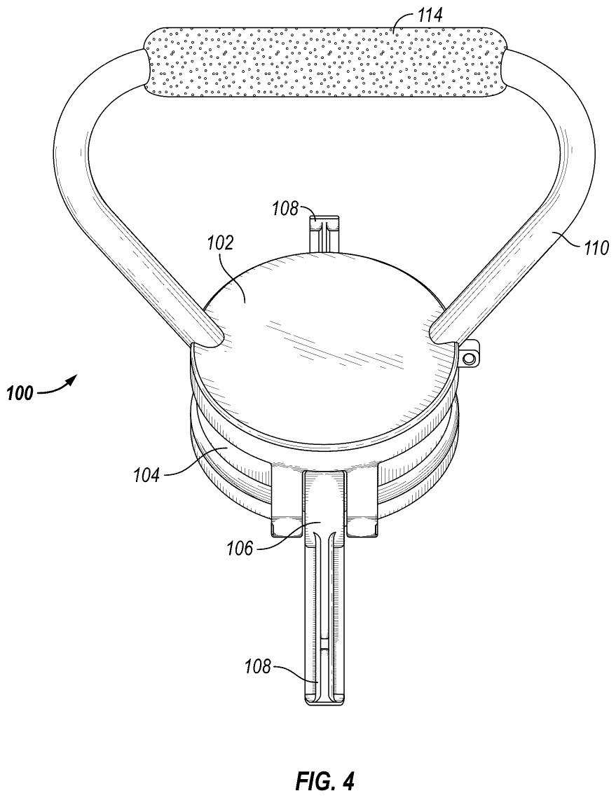

FIG. 4 is an isometric, top, outside view of a camlock cover 100 in accordance with disclosed embodiments. As shown, embodiments of camlock cover 100 may include a comfort or grip aid 114 on handle 110. Embodiments of grip aid 114 may include rubber, foam, vinyl, combinations of the foregoing, and the like to assist the operator in maintaining a firm, comfortable grip on handle 110. In some embodiments, grip aid 114 may comprise a tape or the like that can be re-applied as desired. In some embodiments, grip aid 114 may be thermally or electrically insulating.

Although various embodiments have been shown and described, the present disclosure is not so limited and will be understood to include all such modifications and variations that would be apparent to one skilled in the art.

What is claimed is:

1. A camlock cover comprising:
an endcap;
a sidewall;
at least one camlock; and
a handle connected to the endcap.

2. The camlock cover of claim 1 wherein the handle is integrally formed on the camlock cover.

3. The camlock cover of claim 1 wherein the handle is welded to the camlock cover.

4. The camlock cover of claim 1 further comprising a grip aid on the handle.

5. The camlock cover of claim 4 wherein the grip aid comprises a thermally insulating material.

6. The camlock cover of claim 4 wherein the grip aid comprises an electrically insulating material.

7. A hose fitting comprising:
an endcap;
a sidewall; and
a handle connected to the endcap.

8. The hose fitting of claim 1 further comprising at least one camlock that secures the hose fitting to a hose end.

9. The hose fitting of claim 7 wherein the handle is integrally formed on the hose fitting.

10. The hose fitting of claim 7 wherein the handle is welded to the hose fitting.

11. The hose fitting cover of claim 7 further comprising a grip aid on the handle.

12. The hose fitting of claim 11 wherein the grip aid comprises a thermally insulating material.

13. The hose fitting of claim 11 wherein the grip aid comprises an electrically insulating material.
